(19) United States
(12) Patent Application Publication
(10) Pub. No.: US 2016/0076567 A1
(43) Pub. Date: Mar. 17, 2016

(54) FASTENING DEVICE

(71) Applicant: BENRINER CO., LTD, Yamaguchi (JP)

(72) Inventor: Hajime YAMAMOTO, Yamaguchi (JP)

(21) Appl. No.: 14/548,062

(22) Filed: Nov. 19, 2014

(30) Foreign Application Priority Data
Sep. 12, 2014 (JP) 2014-186320

(51) Int. Cl. F16B 5/02; F16B 33/02

(52) U.S. Cl. CPC F16B 5/02; F16B 33/02

(57) ABSTRACT

A fastening device that easily fixes a member to be fixed and a base member made of resin to each other. A fastening device 100 is provided with an embedded nut 120 that is inserted through a through hole a1 of a base member A from below so as to be formed in the base member A and a bolt 110 that is inserted through a through hole b1 of a member B to be fixed and meshed with the embedded nut 120 of the base member A from above, and the embedded nut 120 has a shaft portion 121 formed into a cylindrical shape, an inner peripheral side screw portion 122 that is formed on the inner periphery of the shaft portion 121 and meshed with the bolt 110 that is inserted from the tip toward the base end of the shaft portion 121, and an outer peripheral side screw portion 123 that is formed on the outer periphery of the shaft portion 121 and meshed with the through hole a1 of the base member A.

### BACKGROUND OF THE INVENTION

1. Field of the Invention

The present invention relates to a fastening device for fixing a base member and a member to be fixed with each other.

2. Description of the Related Art

Conventionally, as a fastening device for use in fixing a base member and a member to be fixed to each other so as to assemble a machine or the like, a structure has been known in which by forming an embedded nut in a base member so as to be embedded therein and a bolt is meshed with the embedded nut while being inserted through the member to be fixed (for example, see JP-A No. 2010-159061).

The embedded nut of this type is sometimes insert-molded within a base member made of resin. For example, JP-A No. 2010-159061 discloses a structure in which upon connecting a main part formed by a blow molding process to a sub-part, nuts are respectively embedded into the main part and the sub-part, and bolts and the nuts are meshed with each other, with an L-letter shaped angle member interposed therebetween.

[Patent Document 1] JP-A No. 2010-159061

In the case when the above-mentioned nut is insert-molded into a base member made of resin, however, since a worker needs to dispose the embedded nut at a predetermined position inside the base member, while the base member is formed in the injection-molding process, a problem is raised in which upon forming the base member including the embedded nut serving as one portion of the fastening device, costs in manpower as well as costs in time are required.

For this reason, technical problems to be solved are raised in an attempt to provide a fastening device that can easily fix the member to be fixed and the base member made of resin to each other, and the object of the present invention is to solve these problems.

### SUMMARY OF THE INVENTION

The present invention, which has been proposed to achieve the above object, includes an invention according to an embodiment that relates to a fastening device for fixing a base member made of resin and a member to be fixed, which is provided with: an embedded nut that is inserted into a through hole of the base member from one of side face sides of the base member; and a bolt that is inserted from the other side face side of the base member and meshed with the embedded nut, and in this structure, the embedded nut is provided with a shaft portion having a cylindrical shape and an inner peripheral screw portion that is formed on the inner periphery of the shaft portion, and capable of being meshed with the bolt that is inserted from the tip of the shaft portion toward the base end, and an outer peripheral screw portion that is formed on the outer periphery of the shaft portion, and capable of being meshed with the through hole of the base member.

In accordance with this structure, by allowing the embedded nut to screw forward in the through hole of the base member to be embedded therein, it is possible to reduce costs in manpower as well as costs in time that are required for manufacturing the base member in comparison with a case where the base member containing the embedded nut is manufactured.

Moreover, by allowing the bolt and the embedded nut to sandwich the base member and the member to be fixed from two sides, that is, one of the side face side and the other side face side, the base member and the member to be fixed can be firmly fixed.

An invention disclosed in another embodiment provides a fastening device in which, in addition to the structure of the fastening device in one embodiment, the shaft portion of the embedded nut is formed into a tapered shape from the base end toward the tip with a gradually narrowed diameter.

In accordance with this structure, upon allowing the embedded nut to be threadedly engaged by the through hole of the base member, since the resistance that is exerted when the embedded nut screws forward in the through hole is reduced, it is possible to easily attach the embedded nut.

In the fastening device in accordance with the present invention, since the embedded nut is allowed to screw forward inside the through hole of the base member and embedded therein, it is possible to reduce costs in manpower as well as costs in time that are required for manufacturing the base member in comparison with the case where the base member containing the embedded nut is manufactured. Moreover, by allowing the bolt and the embedded nut to sandwich the base member and the member to be fixed from two sides, that is, one of the side face side and the other side face side, the base member and the member to be fixed can be firmly fixed with each other.

### BRIEF DESCRIPTION OF THE DRAWINGS

FIGS. 1A and 1B are views showing a bolt for use in a fastening device related to one embodiment of the present invention; FIG. 1A is a plan view thereof; and FIG. 1B is a side face view thereof.

FIGS. 2A and 2B are views showing an embedded nut for use in the fastening device related to the embodiment of the present invention; FIG. 2A is a plan view thereof; and FIG. 2B is a side face view thereof.

FIG. 3 is a perspective exploded view that schematically shows a fixed structure by the use of the fastening device related to the embodiment of the present invention.

FIGS. 4A, 4B, and 4C are views showing a fixed structure of the fastening device; FIG. 4A is a view showing a state prior to threadedly engaging the embedded nut with a based member; FIG. 4B is a view showing a state in which the embedded nut is threadedly engaged with the base member; and FIG. 4C is a view showing a state in which a bolt is threadedly meshed with the embedded nut.

### DETAILED DESCRIPTION OF THE PREFERRED EMBODIMENTS

The present invention, which has been proposed to achieve the object for providing a fastening device that can easily fix the member to be fixed and the base member made of resin to each other, provides the fastening device for fastening the base member made of resin and the member to be fixed to each other having: an embedded nut that is inserted into a through hole of the base member from one of side face sides of the base member; and a bolt that is inserted from the other side face side of the base member and meshed with the embedded nut, and in this structure, the embedded nut is provided with a shaft portion having a cylindrical shape and an inner peripheral screw portion that is formed on the inner periphery of the shaft portion, and capable of being meshed with the bolt that is inserted from the tip of the shaft portion toward the base end, and an outer peripheral screw portion that is formed on the outer periphery of the shaft portion, and capable of being meshed with the through hole of the base member; thus, the object of the present invention is achieved.

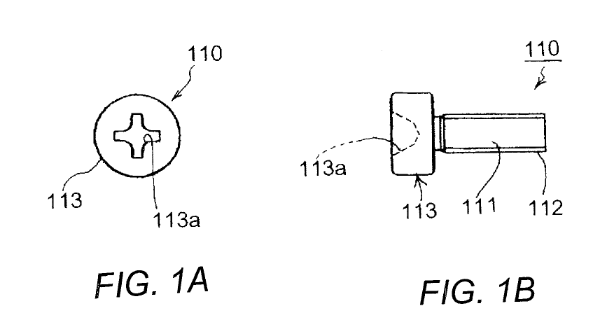

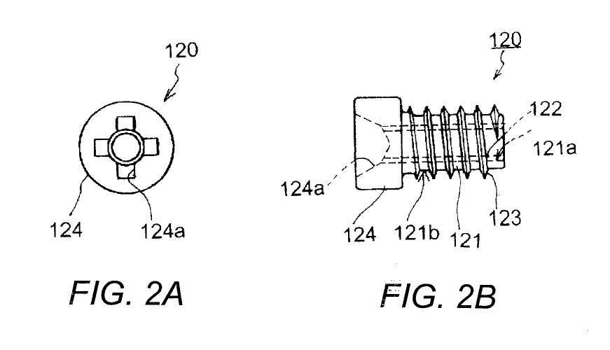

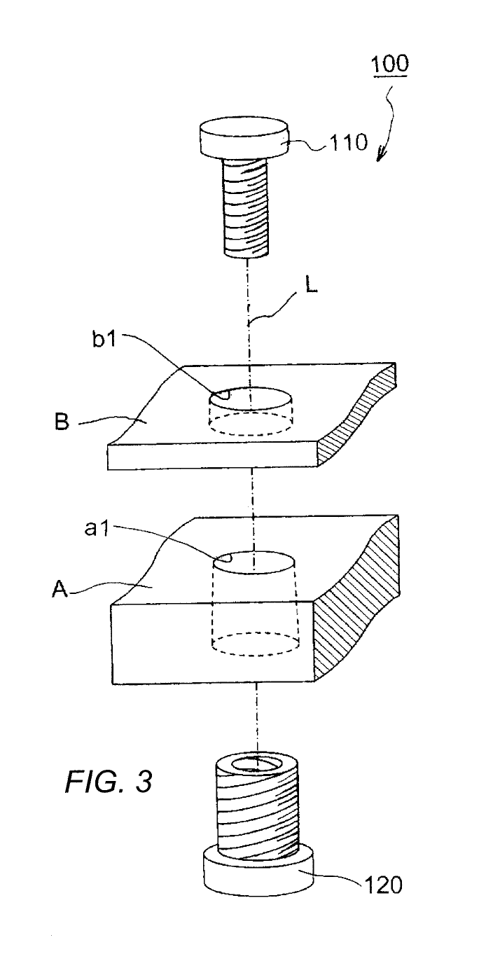

Referring to FIGS. 1 to 3, the following description will discuss a fastening device 100 relating to one embodiment of the present invention.

The fastening device 100 is provided with a bolt 110 and an embedded nut 120. Although the bolt 110 and the nut 120 are made of steel, any material may be used for these, as long as it has desirable durability.

The bolt 110 is provided with a shaft portion 111, a screw portion 112 and a head portion 113. The screw portion 112 is formed on the outer periphery of the shaft portion 111. On the head portion 113, a screw hole 113a, which is formed into a cross shape when seen in a plan view and capable of being engaged with a screw driver or the like, is formed. In the present embodiment, the outer diameter of the screw portion 112 is set to 4 mm.

The embedded nut 120 is provided with a shaft portion 121 having a cylindrical shape, an inner peripheral side screw portion 122, an outer peripheral side screw potion 123 and a head portion 124. The inner peripheral side screw potion 122 is formed on an inner peripheral surface 121a of the shaft portion 121. The outer peripheral side screw portion 123 is formed on an outer peripheral surface 121b of the shaft portion 121. In the present embodiment, the inner diameter of the inner peripheral side screw portion 122 is set to 4 mm, and the outer diameter of the outer peripheral side screw portion 123 is set to 8 mm. On the head portion, a screw hole 124a, which is formed into a cross shape when seen in a plan view and capable of being engaged with a screw driver or the like, is formed.

The bolt 110 and the embedded nut 120 are used for fixing a base member A made of ABS resin and a member B to be fixed made of stainless steel in a state where they are disposed on the same axial line L. More specifically, the embedded nut 120 is threadly engaged with a through hole a1 from below the base member A, and the bolt 110 is inserted through a through hole b1 of the member B to be fixed, and meshed with the inner peripheral side screw portion 122 of the embedded nut 120 from above the base member B. With respect to the material for the base member A, not limited to ABS resin, any resin, such as acrylic resin, polypropylene resin, polyethylene resin, or the like, may be used.

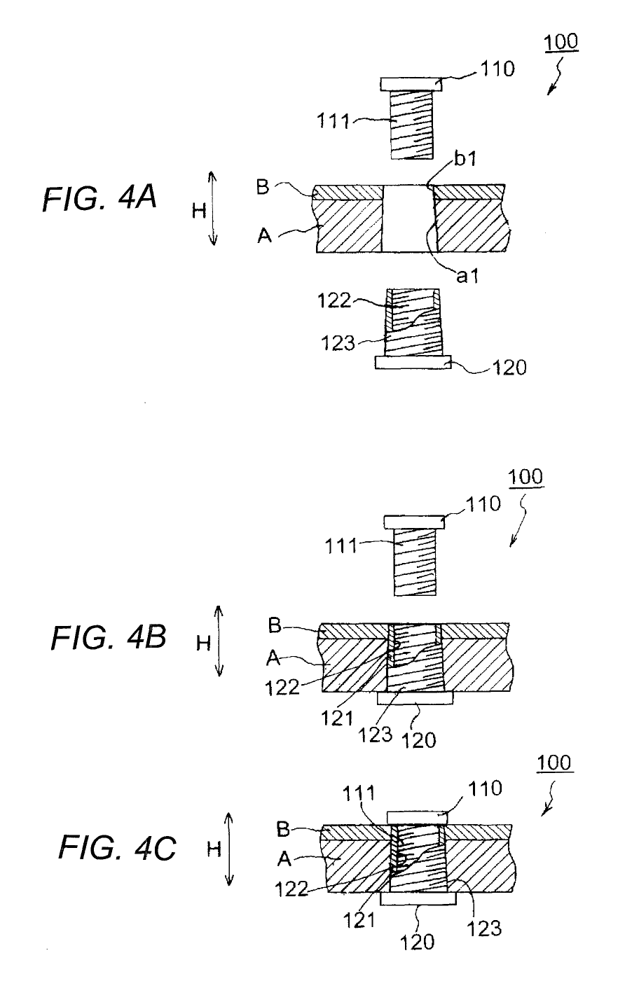

Referring to FIGS. 4A to 4C, the following description will discuss a sequence of processes for fixing the base member A and the member B to be fixed by using the fastening device 100. FIGS. 4A to 4C are cross-sectional views that schematically show the fixing structure of the fastening device 100. Additionally, the embedded nut 120 in FIGS. 4A to 4C is illustrated, with one portion of the tip being exploded.

As shown in FIG. 4A, the embedded nut 120 is disposed on the lower side in the vertical direction H and the bolt 110 is disposed on the upper side, with the base member A and the member B to be fixed being sandwiched therebetween. Additionally, in the case when the base member A is disposed above the member B to be fixed, the embedded nut 120 is disposed on the upper side of the bolt 110.

When the embedded nut 120 is allowed to screw forward inside the nut attaching hole a1 of the base member A by a screw driver or the like and further screw forward by a predetermined amount, it is threadedly engaged with the base member A and the member B to be fixed, as shown in FIG. 4B. At this time, since the shaft portion 121 of the embedded nut 120 is formed into a tapered shape, with a gradually narrowed diameter from the base end toward the tip, the embedded nut 120 can be screwed forward inside the through hole a1 by using a smaller force when the embedded nut 120 is attached to the base member A.

Next, as shown in FIG. 4C, the bolt 110 is meshed with the inner peripheral side screw portion 122 of the embedded nut 120 by a screw driver or the like so that the base member A and the member B to be fixed are fixed in a manner so as to be sandwiched by the bolt 110 and the embedded nut 120 from above as well as from below. Thus, since the bolt 110 is not meshed with the soft base member A, but meshed with the embedded nut 120 so that even in the case when the bolt 110 is repeatedly subjected to attaching and detaching processes, it is possible to suppress a reduced fastening force caused by the deformation or the like of the base member A.

In this manner, in the fastening device 100 in accordance with the present embodiment, by allowing the embedded nut 120 to screw forward inside the through hole a1 of the base member A and embedded therein, it is possible to reduce costs in manpower as well as costs in time that are required for manufacturing the base member A in comparison with a case where the base member containing the embedded nut 120 is manufactured. Moreover, by allowing the bolt 110 and the embedded nut 120 to sandwich the base member A and the member B to be fixed from above as well as from below, it becomes possible to firmly fix the base member A and the member B to be fixed.

Additionally, in the present invention, various modifications may be made within the scope without departing from the gist of the present invention, and those modifications are of course included within the scope of the present invention.

### EXPLANATIONS OF REFERENCE NUMERALS

100 FASTENING DEVICE
110 BOLT
111 SHAFT PORTION
112 SCREW PORTION
113 HEAD PORTION
113a SCREW HOLE (OF BOLT)
120 EMBEDDED NUT
121 SHAFT PORTION
121a INNER PERIPHERAL SURFACE
121b OUTER PERIPHERAL SURFACE
122 INNER PERIPHERAL SIDE SCREW PORTION
123 OUTER PERIPHERAL SIDE SCREW PORTION
124 HEAD PORTION
124a SCREW HOLE (OF EMBEDDED NUT)
A BASE MEMBER
a1 THROUGH HOLE (OF BASE MEMBER)
B MEMBER TO be FIXED
b1 THROUGH HOLE (OF MEMBER TO BE FIXED)

What is claimed is:

1. A fastening device for fixing a base member made of resin and a member to be fixed to each other, comprising:
an embedded nut that is inserted into a through hole of the base member from one of side face sides of the base member; and
a bolt that is inserted through a through hole of the member to be fixed, and meshed with the embedded nut from the other side face side of the base member,
wherein the embedded nut further comprises a shaft portion having a cylindrical shape and an inner peripheral screw portion that is formed on the inner periphery of the shaft portion, and capable of being meshed with the bolt that is inserted from the tip of the shaft portion toward the base end, and an outer peripheral screw portion that is formed on the outer periphery of the shaft portion, and capable of being meshed with the through hole of the base member.

2. The fastening device according to claim 1, wherein the shaft portion of the embedded nut is formed into a tapered shape from the base end toward the tip with a gradually narrowed diameter.
